(19) United States
(12) Patent Application Publication
(10) Pub. No.: US 2009/0001973 A1
(43) Pub. Date: Jan. 1, 2009

(54) Magnetic Sensor Arrangement for Defined Force Transmission

(76) Inventors: Lutz MAY, Berg (DE); Johannes Giessibl, Amerang (DE); Bastian Steinacher, Munchen (DE)

Correspondence Address: FAY KAPLUN & MARCIN, LLP, 150 BROADWAY, SUITE 702, NEW YORK, NY, 10038, US

(21) Appl. No.: 12/127,132

(22) Filed: May 27, 2008

Related U.S. Application Data
(60) Provisional application No. 60/946,798, filed on Jun. 28, 2007.

(30) Foreign Application Priority Data
Jun. 28, 2007 (EP) 07 012 720.4

(51) Int. Cl. G01B 7/24

(52) U.S. Cl. 324/209

(57) ABSTRACT

A magnetization arrangement includes an inner element having an outer surface, an outer element having an inner surface, a connecting device, and a magnetic field measuring device. At least one element of the inner and outer element has a magnetizable area. The magnetic field measuring device is designed to measure a magnetic field generated by the magnetized magnetizable area. The connecting device joins the inner surface of the outer element and the outer surface of the inner element non-positively in such a way that a force acting on the magnetic sensor device can be transmitted in a defined manner between the outer element and the inner element.

### REFERENCED APPLICATIONS

This application claims the benefit of the filing date of U.S. Provisional Patent Application Ser. No. 60/946,798 filed Jun. 28, 2007 and European Patent Application Serial No. 07012720.4-1215 filed Jun. 28, 2007, the disclosures of which are hereby incorporated herein by reference.

### FIELD OF THE INVENTION

The present invention relates to a magnetic sensor arrangement, in particular a magnetic sensor arrangement, which permits the defined transmission of force acting on a magnetic sensor arrangement between an outer element and inner element.

### BACKGROUND OF THE INVENTION

For example, magnetic sensors can be used to acquire a deformation caused by a dynamic effect. To this end, an element is provided with a magnetizable area, for example, which can be magnetized via the generation of an external magnetic field. For example, if two magnetized areas of different polarity are situated next to or over each other, the resultant magnetic field can be measured from outside. If the two magnetic field are equally strong at the measuring point, the magnetic fields neutralize each other completely. A deformation makes it possible for the two magnetized areas to shift relative to each other, so that the fields no longer neutralize each other in the measuring point, for example, so that the slightest deformations can already be quantitatively ascertained as well. Such magnetic sensors are known form WO 2005/064302, for example.

However, a displacement of the sensor arrangement can lead to a deformation of the sensor that no longer corresponds with the force acting on the sensor arrangement. This may result in a nonlinear behavior of a sensor, or a no longer predictable behavior of the sensor, which could render the sensor largely useless.

### SUMMARY OF THE INVENTION

There may be a need for preventing an undefined force transmission between two elements, and providing a magnetic sensor arrangement that has an improved signal quality of a measuring signal to be measured.

In an exemplary embodiment of the invention, a magnetic sensor arrangement is provided with an inner element having an outer surface, an outer element having an inner surface, a connecting device, and a magnetic field measuring device, wherein at least one element of the inner and outer element has a magnetizable area, wherein the magnetic field measuring device is designed to measure the change in a magnetic field generated by the magnetized, magnetizable area, and wherein the connecting device non-positively joins together the inner surface of the outer element and the outer surface of the inner element in such a way that a force acting on the magnetic sensor arrangement can be transmitted in a defined manner between the outer element and the inner element.

This type of arrangement makes it possible to avoid an undefined force transmission or undefined force and tension progressions that may arise between an inner element and outer element, for example if the latter are interconnected with an interference fit. For example, the magnetic sensor arrangement can consist of a magnetic sensor and a component, wherein the force acting on the component is transmitted in a defined manner to the magnetic sensor in such a way that the latter can be deformed corresponding to the force acting on the magnetic sensor arrangement, specifically essentially without any disruptive influence of undefined initial forces, which as a rule arise due to an interference fit of the sensor and component. Since the sensors described above in prior art and manufactured by the applicant NCTE have peak levels of sensitivity that also enable the measurement of the smallest dynamic effects based on this technique, minimal irregularities during the manufacture of fits measuring a few micrometers or even less can already lead to a no longer reproducible force distribution, potentially making a precise and sensitive measurement impossible. A defined force transmission can make the force transmission reproducible again, so that magnetic sensor arrangements with magnetic sensors pressed into a component can also enable an exact measurement.

In an exemplary embodiment of the invention, the force acting on the magnetic sensor arrangement can be transmitted via discrete linear or point surfaces between the outer element and the inner element.

In this way, the dynamic effect between the inner and outer element no longer takes place via a common peripheral surface resulting in a bias owing to irregularities present on the peripheral surface, but rather via defined lines or point surfaces. Linear or point surfaces are here surfaces that run along a straight or curved line, or around a point, and the certain width they do have is smaller or even much smaller relative to the entire peripheral surface. This makes it possible to keep the area next to the linear or point surfaces free from exposure to forces. In other words, the dynamic effect between an inner and outer element takes place by way of previously known, and hence calculable, connecting surfaces, wherein irregularities between them can no longer exert any undesired dynamic effects.

In an exemplary embodiment of the invention, the connecting device encompasses at least one elongated element, whose elongating direction has a directional component that extends in a direction parallel to a plane in which the force acting on the magnetic sensor arrangement acts.

Such an arrangement absorbs in particular forces in a direction corresponding to a desired force measuring direction.

In an exemplary embodiment of the invention, the inner element and outer element have a corresponding longitudinal elongating direction, and the connecting device encompasses at least one elongated element with a directional component extending in the longitudinal elongating direction.

In an exemplary embodiment of the invention, the elongated element runs parallel to the longitudinal elongating direction.

The force is transmitted between the inner and outer element exclusively via the elongated elements, which represent the connection between the inner and outer element. As a result, other forces that do act, but are not necessary measured, can be at least partially eliminated.

In an exemplary embodiment of the invention, the inner element and outer element are essentially cylindrical in an area of the connecting device that joins them.

This makes it possible to use easily manufactured cylindrical pars. However, conical elements joined together via connecting devices are also conceivable. Application can depend on the installation site and measured variables.

In an exemplary embodiment of the invention, the inner element and outer element are essentially circularly cylindrical in an area of the connecting device that joins them.

Circularly cylindrical elements can be easily fabricated using machine tools with a rotating work pieces. However, these can also be cylindrical shapes that have an oval, elliptical, triangular, square, polygonal or freely shaped area. This shape can depend on the installation site and measured variables.

In another exemplary embodiment of the invention, the connecting device is at least partially designed as a single piece with at least one of the inner and outer elements.

For example, a elongated element can be provided in the form of a web or bar on either the inner or also the outer element. The manufacture of such geometries is common knowledge to the expert. For example, one or more webs or bars can be provided on the inner element, and one or more webs or bars on the outer element, so that a mixed form can be present between elongated elements, provided in part on the inner element, and in part on the outer element.

In an exemplary embodiment of the invention, the connecting device has at least two elongated elements that lie in a shared plane with the force acting on the magnetic sensor arrangement.

Such an arrangement enables a good transmission of force between the inner and outer element given a force acting in this direction. The force then acts on these web elements perpendicularly, thereby ensuring a particularly good force coupling.

In an exemplary embodiment of the invention, the connecting device has at least four elongated elements that extend at an angle of essentially 90 degrees relative to a central axis of the inner element to each other in the longitudinal direction.

The uniform distribution enables a good force coupling. The laterally elongated elements in the direction of force in an alignment of two opposing elongated elements enables a stable force coupling.

In another exemplary embodiment of the invention, the elongated elements exhibit recesses in their longitudinal direction that at least partially interrupt a non-positive connection of the elongated elements.

This makes it possible to form various sections in the longitudinal direction that can also be evaluated separately. The individual sections can here be provided with separate magnetizable areas, along with separate magnetic field measuring devices. This enables a differentiation between compressive and tensile forces of the kind encountered in bending moments, for example. In particular, a bending force can be differentiated from an axially acting force.

In an exemplary embodiment of the invention, the connecting device has at least two essentially point-like connections, which are arranged on an imaginary line in the longitudinal direction.

In addition to linear surfaces, point surfaces can be used for joining the first and second element. This also makes it possible to generate a matrix by which the force acts between the inner and outer element. For example, such a matrix can be easily manipulated or handled in terms of its dynamic effect via a finite element program.

In an exemplary embodiment of the invention, the magnetizable area is provided on the inner element.

In an exemplary embodiment of the invention, the inner element is tubular in design, wherein the magnetic field measuring device is arranged inside the tubular inner element inside a magnetic field.

Such an arrangement makes it possible to provide a magnetic sensor in a component functioning as the outer element, in which, for example, only a borehole need be incorporated to accommodate the inner element functioning as the magnetic sensor.

In an exemplary embodiment of the invention, the magnetizable area is provided on the outer element.

In an exemplary embodiment of the invention, the outer element is tubular in design, wherein the magnetic field measuring device is arranged outside the tubular outer element within a magnetic field.

This makes it possible to also provide shafts with a magnetic sensor. As the inner element, the shaft then represents the component upon which a force acts, while the tubular outer element represents the magnetic sensor.

In an exemplary embodiment of the invention, one of the inner element and outer element is a component upon which an external force acts, and the other of the inner element and outer element is the element that has a magnetized area.

Of course, the individual features can also be combined among each other, in part yielding advantageous effects going beyond the sum of individual effects.

These and other aspects of this invention will be explained and illustrated by referring to the exemplary embodiments described below.

### BRIEF DESCRIPTION OF DRAWINGS

Exemplary embodiments will be described below with reference to the following drawings.

FIG. 1 shows a schematic arrangement of a magnetic sensor arrangement according to an embodiment of the invention.

FIG. 2 shows a perspective view of an inner element of a magnetic sensor arrangement according to an exemplary embodiment of the invention.

FIG. 3 shows a sectional view of an inner element of a magnetic sensor arrangement according to an exemplary embodiment of the invention.

FIG. 4 shows various cross sectional forms of a first element according to an exemplary embodiment of the invention.

FIG. 5 shows another exemplary embodiment of a magnetic sensor arrangement.

FIG. 6 shows another exemplary embodiment of a magnetic sensor arrangement.

FIG. 7 shows another exemplary embodiment of a magnetic sensor arrangement.

FIG. 8 shows a perspective view of an inner element with elongated elements of a connecting device.

FIG. 9 shows a segmented, elongated element on an inner element according to an exemplary embodiment of the invention.

FIG. 10 shows point-like elements of a connecting device according to an exemplary embodiment of the invention.

FIG. 11 shows elements of a connecting device that extend in the peripheral direction of the first element.

FIG. 12 shows various exemplary embodiments of the invention, in which the outer element is joined with the connecting device.

FIG. 13 shows an embodiment in which the outer element has a magnetizable area.

### DETAILED DESCRIPTION OF EXEMPLARY EMBODIMENTS

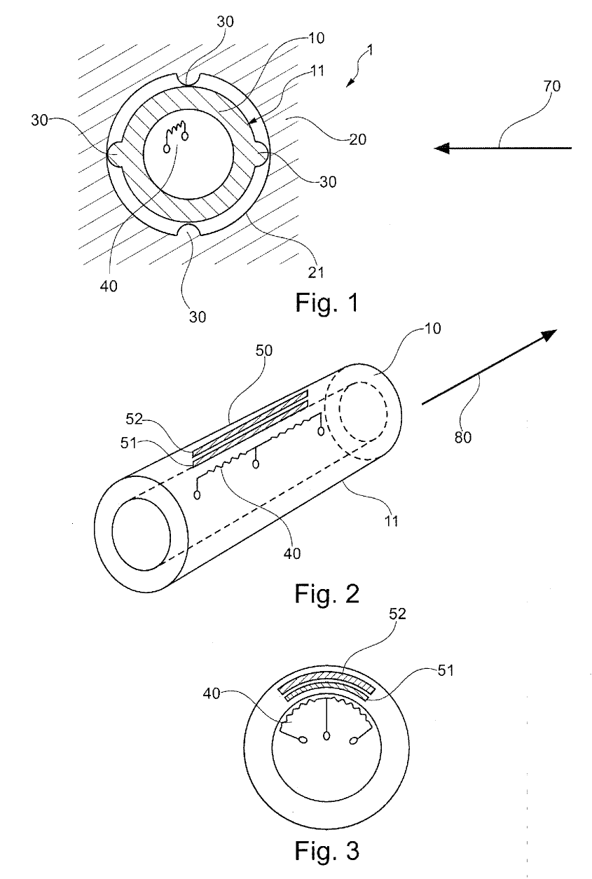

FIG. 1 shows an embodiment of this invention in which an inner element 10 with an outer surface 11 is situated inside an outer element 20 with an inner surface 21, wherein the inner element 10 and the outer element 20 are joined with a connecting device 30 in such a way as to achieve a non-positive connection between the first element 10 and the second element 20. In the embodiment shown on FIG. 1, the elements of the connecting device 30 are partially designed as a single piece with the first element 10, and partially designed as a single piece with the second element 20. Of course, the elements of the connecting device can be exclusively designed as a single piece with either the inner element 10 or the outer element 20. In an embodiment not shown here, the connecting device can also be designed as a separate element, e.g., a cage, providing a defined, non-positive connection between the inner element 10 and the outer element 20. In the arrangement shown on FIG. 1, the magnetizable area 50 is not shown in detail. Further, the device has a magnetic measuring device 40 with which a magnetized magnetizable area 50, 51, 52 can be measured.

FIG. 2 shows a perspective view of an inner element 10 with an outer surface 11 according to an exemplary embodiment of the invention. A first sub-area 51 and second sub-area 52 can be provided in the wall of the first element 10, which is here tubular, wherein the first sub-area can be magnetized with a first polarity, for example, while the second area 52 can be magnetized with a polarity set opposite the first polarity. The magnetic measuring device 40 can be a coil arrangement, for example. The coil arrangement shown on FIG. 2 consists of two serially connected coils, which permit a kind of bridge circuit, thereby enabling better balancing during magnetic field measurement. The two layers 51 and 52 lying one over the other enhance one another in their magnetic field inducing effect, so that the magnetic field measuring device 40 can only measure a diminished magnetic field or no magnetic field. For example, if the inner element 11 is deformed, the first area 51 and second area 52 of the magnetizable area 50 shift relative against each other, so that the resulting magnetic field changes at this location, as can be measured with the magnetic field measuring device 40.

FIG. 3 shows an exemplary sectional view of the arrangement shown on FIG. 2. A first area 51 and second area 52 of a magnetizable area 50 are also provided in the arrangement shown on FIG. 3. The magnetic field measuring device 40 consists of two serially connected coils here as well, but as opposed to FIG. 2, in which these coils are arranged in the longitudinal direction, the coils are arranged in a circumferential direction on FIG. 3. Based on this fact, the device shown on FIG. 2 and the device shown on FIG. 3 can be used to measure various directional forces, e.g., a torsional force, longitudinal force, transverse force or a mixture thereof.

The arrangement depicted on FIG. 1 shows that the inner element 10 and outer element 20 are only connected non-positively at discrete points by the connecting device 30. This makes it possible to avoid an indifferent displacement of the two elements 10, 20 relative to each other, which can arise, for example, during an interference fit, so that the force is only transmitted at discrete points via the connecting device 30. As a result, the signals measurable by the magnetic field measuring device are far more reproducible than given a press-fit device, which are in contact over the entire peripheral surface of the inner element and outer element. The slightest irregularities can already bring about a measurable deformation, which can no longer be reproduced given contacting and force transmission over a large surface area.

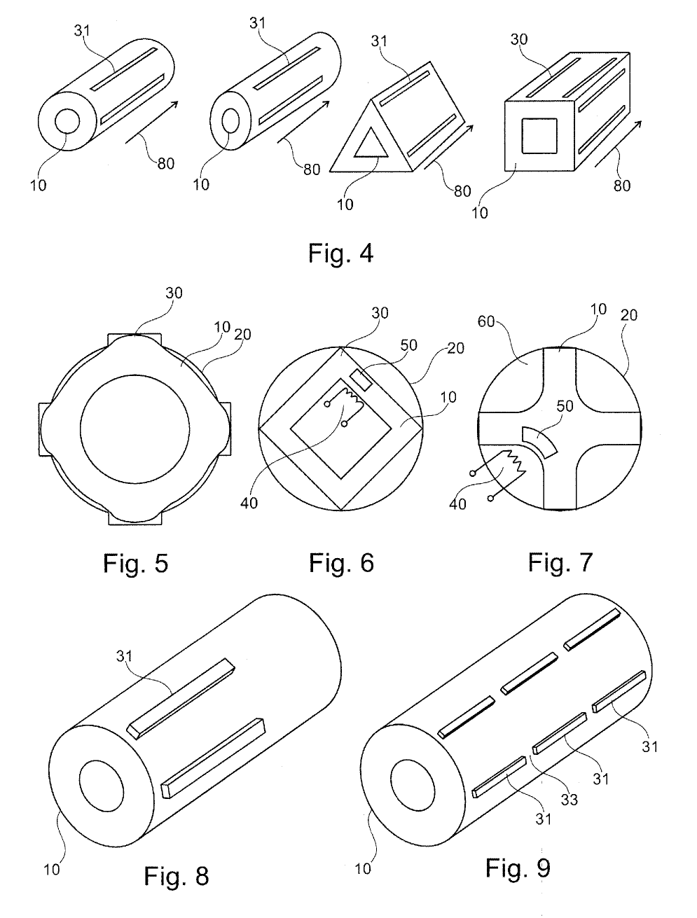

FIG. 4 shows a plurality of configurations of the inner element 10. In this case, both the inner element 10 and outer element 20 can be cylindrical, e.g., circularly cylindrical, elliptically cylindrical, triangularly cylindrical or square cylindrical. However, this invention is not limited to such cross sectional shapes, since the cross section can be any freely shaped surface. In the embodiment shown on FIG. 4, elongated elements are provided on the inner element 10 in the form of linear surfaces 31, which yields the non-positive connection between the inner element 10 and outer element 20. The inner element 10 and outer element 20 can continue to be pressed into each other, but the force is no longer transmitted over a large surface, but rather only via the elongated elements in the form of a linear element.

FIG. 5 shows an exemplary embodiment of the invention, in which no explicit elevations are provided, e.g., on the outer element, but rather recesses are provided as the connecting device 30. While pressing the inner element 10 and outer element 20, for example, the material may become deformed, thereby elevating the inner element by way of the recesses in the outer element. For example, this makes it possible to generate defined lines of force, which permit a defined transmission of forces between the inner element and outer element.

FIG. 6 shows an exemplary embodiment, in which an inner element 10 with a square or generally polygonal cross section is pressed into an outer element 20 with an essentially round cross section. As a result, it is not absolutely necessary to form elevations, since the corners of the square serve as the connecting device that joins the inner element 10 with the outer element 20.

FIG. 7 shows another exemplary embodiment of the invention, in which a cruciform inner element 10 is pressed into a circular outer element 20. In this case, for example, the arising gaps 60 can be made to accommodate the magnetic field measuring device 40, wherein the magnetizable area 50 can be provided in the cruciform inner element 10. Of course, the magnetizable area 50 can also be replaced by several nested or stacked magnetizable areas, although this is not shown on FIG. 7 for purposes of clarity.

FIG. 8 shows an exemplary embodiment of the invention, in which elongated elements 31 are arranged in the longitudinal direction on the inner element 10. By contrast, FIG. 9 shows that the elongated elements 31 are interrupted on the inner element 10 by recesses 33, so that the areas can be divided up. In like manner, separately magnetizable areas can also be provided in the areas of the individual segments of the elongated elements 31, but these are not separately depicted on FIG. 9. Similarly, of course, various magnetic field measuring devices can be provided based on the different magnetizable areas, so that separate sectional measurements can be performed. For example, if a bending force acts on the inner element 10, deformation is positive at some locations and negative at others. By contrast, when force is applied in a strictly orthogonal direction relative to the elongated axis of the inner element, deformation will be identical in all three areas, so that a bending load can be distinguished form an axial load in the radial direction of the elongated direction of the inner element.

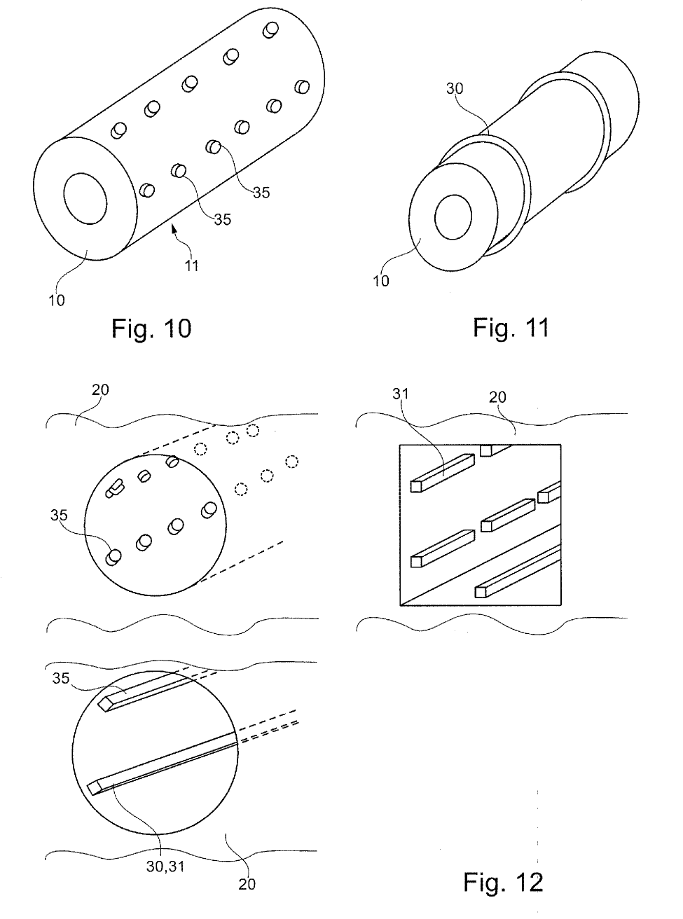

FIG. 10 shows an exemplary embodiment of the invention, in which point surface-type connecting elements 35 can be provided on the inner element 10, making it possible, for example, to generate a matrix that can be balanced owing to its discrete points, e.g., using a finite element program.

FIG. 11 shows an exemplary embodiment of the invention in which the elongated elements of the connecting device 30 do not run in the longitudinal direction of the inner element 30, but rather in the peripheral direction. This type of arrangement makes sense when forces are to be measured in other directions.

FIG. 12 shows exemplary embodiments in which the connecting device 30 is provided on the outer element 20. For example, point surfaces 35 can here be provided as connecting device elements, but also elongated elements 31 in the form of linear surfaces, which are used for non-positive contacting.

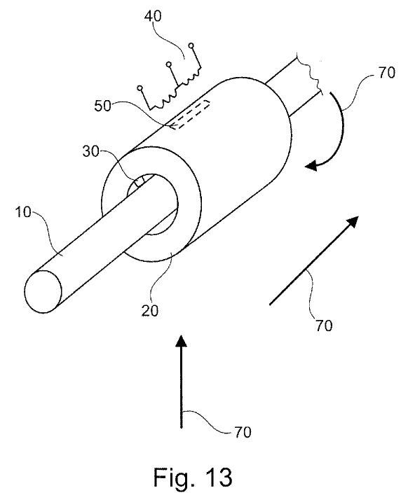

FIG. 13 shows an embodiment in which a magnetizable area 50 is provided in the outer element 20. The magnetic field measuring device 40 is here provided outside the outer element. This embodiment is particularly relevant arrangements in which forces on shafts are to be measured. The dynamic effect 70 can here take place in both an axial direction and a radial direction, as well as in a torsional direction. The direction in which the connecting device elements elongate then depends on the desired force to be measured.

In a hole of the component, four grooves can be incorporated where the sensor is fit in as a tube, e.g., at 12 o'clock, 3 o'clock, 6 o'clock and 9 o'clock, i.e., divided into quarters. These grooves can only be a few micrometers deep, and prevent the force from propagating that spontaneously and then attacking some other location in the tube. This effect can be achieved by both elevations and depressions. The elevations represent connecting surfaces at which the tube as the inner element and the component as the outer element are joined. The depression in the form of grooves can also represent lines of force in the pressing in process, which enable a defined force transmission. This creates a situation in which the forces must actually enter via the surfaces.

It has been determined that, when pressing in the tube, even hundredths of a millimeter in the hole size make a big difference in the measurement at the magnetic sensor. Holes cannot be economically drilled to such an accuracy, in particular not given high part counts of the kind common in automotive construction, for example. The magnetic field measuring device can be a coil arrangement, or any other arrangement, such as Hall sensors, etc. Depending on how the coils are placed from outside, bending forces in various directions can be measured for a rod. For example, the tube can be magnetized by pinnings, i.e., magnetized areas that can be generated by current pulses in varying heights and varying current directions. A wire can also be guided through the tube, after which the tube can be magnetized from the inside out via a current injection from the PCME. Hence, magnetization can take place from the outside in and from the inside out. However, the wire is only used for magnetization, not measurement. The magnetic coding is normally implemented from outside by applying contacts to the tube accordingly. Contactless magnetization is possible from the inside without the wire touching the wall. The tube can then be pressed into any material desired, e.g., steel, aluminum, etc. The field lost from outside plays no significant role, and only the field acting from inside is of interest. However, distortions in the in the tube adversely affect the measurement result. The tube can also be pressed in by making space and filling with filler at the connecting device, which then hardens and generates an actual tension. Under certain conditions, a screwed clamping generates new distortions via the screws themselves.

The formation of a web or bar can take place on the sleeve or tube and in the borehole. A defined support surface must be present. This can be accomplished by giving the sleeve this form, or in the end designing the hole accordingly. It is important to generate a defined frictional connection to avoid a positioning inaccuracy of the sleeve. If the sleeve were to outwardly project, it would have to be inserted very precisely into the hole. At a respective 90°, the circular segments can be left standing homogeneously, depending on how much is necessary.

The cross section can be square, rectangular, triangular or polygonal, wherein the force entry points are in the corners for the square/rectangle. An ellipse can become relevant given only a limited material thickness. A borehole need here not necessary be cylindrical; it can also be conical.

The connection can also consist of a number of balls, e.g., four balls. The signal might deteriorate if only various points are present in the longitudinal direction, since the dynamic effect might not be that good any more. Pre-stress at such locations represents a problem when they are no longer homogeneous, which is often the case given a press fitting.

It should be noted that, in addition to magnetic sensors, this invention can be used for sensors other than magnetic sensors, in particular if this enables the conversion of pre-stress, for example, into a defined dynamic effect and force transmission via interference fits.

Let it be noted that the term “comprise” does not exclude other elements or procedural steps, just as the term “an” and “a” do not preclude several elements and steps.

The used reference numbers are used only to enhance understanding, and should in no way be regarded as limiting, wherein the scope of protection of the invention is reflected in the claims.

1. A magnetic sensor arrangement, comprising
an inner element having an outer surface;
an outer element having an inner surface;
a connecting device; and
a magnetic field measuring device;
wherein at least one element of the inner and outer element comprises a magnetizable area;
wherein the magnetic field measuring device measures a change of a magnetic field generated by the magnetized magnetizable area, and
wherein the connecting device joins the inner surface and the outer surface non-positively in such a way that a force acting on the magnetic sensor device is transmitted in a defined manner between the outer element and the inner element.

2. The magnetic sensor arrangement of claim 1, wherein the force acting on the magnetic sensor arrangement is transmitted via one of discrete linear surfaces and point surfaces between the outer element and the inner element.

3. The magnetic sensor arrangement of claim 1, wherein the connecting device comprises at least one elongated element, an elongating direction of the at least one elongated element having a directional component that extends in a direction parallel to a plane in which the force acting on the magnetic sensor arrangement acts.

4. The magnetic sensor arrangement of claim 1, wherein the inner element and outer element comprises a corresponding elongated direction, and the connecting device includes at least one elongated element having a directional component that runs in the elongated direction.

5. The magnetic sensor arrangement of claim 2, wherein the elongated element runs parallel to the elongated direction.

6. The magnetic sensor arrangement of claim 1, wherein the inner element and outer element are essentially cylindrical in an area of connecting device that joins them.

7. The magnetic sensor arrangement of claim 1, wherein the inner element and outer element are circularly cylindrical in an area of connecting device that joins them.

8. The magnetic sensor arrangement of claim 1, wherein the connecting device is at least partially designed as a single piece with at least one of the inner and outer elements.

9. The magnetic sensor arrangement of claim 1, wherein the connecting device comprises at least two elongated elements that lie in a shared plane with the force acting on the magnetic sensor arrangement.

10. The magnetic sensor arrangement of claim 4, wherein the connecting device has at least four elongated elements that extend at an angle of essentially 90 degrees relative to a central axis of the inner element to each other in the longitudinal direction.

11. The magnetic sensor arrangement of claim 3, wherein the elongated elements have recesses in their longitudinal direction that at least partially interrupt a non-positive connection of the elongated elements.

12. The magnetic sensor arrangement of claim 1, wherein the connecting device has at least two essentially point-like connections, which are arranged on an imaginary line in the longitudinal direction.

13. The magnetic sensor arrangement of claim 1, wherein the magnetizable area has an annular first sub-area magnetized with a first polarity, and a second annular sub-area magnetized with a polarity opposite the first polarity.

14. The magnetic sensor arrangement of claim 1, wherein the magnetized area is provided on the inner element.

15. The magnetic sensor arrangement of claim 14, wherein the inner element is tubular in design, wherein the magnetic field measuring device is arranged inside the tubular inner element within a magnetic field.

16. The magnetic sensor arrangement of claim 1, wherein the magnetizable area is provided on the outer element.

17. The magnetic sensor arrangement of claim 16, wherein the outer element has a tubular shape, and wherein the magnetic field measuring device is arranged outside the tubular outer element within a magnetic field.

18. The magnetic sensor arrangement of claim 1, wherein one of the inner element and outer element is a component upon which an external force acts, and the other of the inner element and outer element is the element that has a magnetized area.
